(19) United States
(12) Patent Application Publication
(10) Pub. No.: US 2016/0328144 A1
(43) Pub. Date: Nov. 10, 2016

(54) USER INTERFACE FOR TOUCH DEVICES

(71) Applicant: SAMSUNG ELECTRONICS CO., LTD., Suwon-si (KR)

(72) Inventors: Pulkit AGRAWAL, Uttar (IN); Lovlesh MALIK, Haryana (IN); Tarun SHARMA, Amritsar Punjab (IN)

(21) Appl. No.: 15/110,267

(22) PCT Filed: Jan. 13, 2015
(86) PCT No.: PCT/KR2015/000308

§ 371 Date: Jul. 7, 2016

(30) Foreign Application Priority Data
Jan. 20, 2014 (IN) 166/DEL/2014

(51) Int. Cl. G06F 3/0488; G06F 3/0484; G06F 3/041

(52) U.S. Cl. CPC G06F 3/04883; G06F 3/0416; G06F 3/04886; G06F 3/04847; G06F 2203/04808

(57) ABSTRACT

Methods and devices for dynamically reconfiguration of user interface on a touch device (100) are described. The touch device (100) includes a touch-screen (108) to receive a user swipe input (202) from a user. Thereafter, the touch device (100) determines a user-touchable area based on the user swipe input (202). Based on a reconfiguration setting, the user interface is reconfigured on the touch-screen (108) within the user-touchable area.

### TECHNICAL FIELD

The present subject matter relates to touch devices and, particularly but not exclusively, to methods and systems for reconfiguring user interface of touch devices.

### BACKGROUND ART

Nowadays, touch devices have increasingly become popular in consumer electronics, such as mobile communication devices, computing devices, global position system (GPS) navigation units, digital video recorders, and other handheld devices. The touch devices generally include a user interface to facilitate user interactions with application programs running on the touch devices. The user interface facilitates the user interactions by simultaneously displaying a number of user interface (UI) elements to a user and receiving user input through, for example, the user's finger(s) or a stylus. The UI elements are generally preconfigured and evenly disposed on entire touch-screen of the touch devices by the manufacturers.

### DISCLOSURE OF INVENTION

### Technical Problem

However, with such preconfigured positioning of the UI elements, it is inconvenient for the users to interact with the UI elements positioned beyond the reach of the user's hand.

### Solution to Problem

The present subject matter relates to systems and methods for dynamic reconfiguration of user interface in touch devices. The methods can be implemented in various touch devices, such as mobile phones, hand-held devices, tablets, netbooks, laptops or other portable computers, personal digital assistants (PDAs), notebooks and other devices that implement a touch-screen or touch-panel.

Typically, a touch device provides various functionalities, for example, accessing and displaying websites, sending and receiving e-mails, taking and displaying photographs and videos, playing music and other forms of audio, etc. These, and numerous other functionalities, are generally performed by execution of an application on selection of the application's icon present on the touch device's user interface. With increasing demands from users for better interaction capabilities and additional functionalities, the touch devices are nowadays configured with touch user interfaces having larger sizes, sometimes even larger than 5 inches.

The touch device configured with larger size touch user interface, as displayed on a touch-screen, commonly has user interface (UI) elements arranged on the entire touch-screen of the touch device. However, the UI elements cannot be scaled and/or positioned as per a user's desire, which can otherwise help to influence user interactions with the touch device. In addition to that, the touch device does not have the capability to reconfigure the UI elements. The UI elements are generally preconfigured and evenly positioned on entire touch-screen of the touch devices by the manufacturers. This often gives rise to a situation in which a few UI elements may be preconfigured beyond a single hand operational capability of the user. Thus, the touch device configured with larger size touch user interface is often operated using both hands.

The subject matter disclosed herein is directed towards systems and methods for reconfiguring user interface on touch devices, for example, for performing single hand operation. In one example, a user defines an area on a touch-screen of a touch device within the reach of a user's hand, and user interface is dynamically configured so that the UI elements are positioned in the reach of the user's hand. In an example, the user's hand includes, without any limitation, user's fingers, user's thumb or other input devices, such as stylus held by the user.

Further, the description hereinafter of the present subject matter includes various specific details to assist in that understanding but these are to be regarded as merely exemplary. Accordingly, those of ordinary skill in the art will recognize that various changes and modifications of the embodiments described herein can be made without departing from the scope and spirit of the present subject matter. In addition, descriptions of well-known functions and constructions may be omitted for clarity and conciseness.

Yet further, the reconfiguration capability of the present subject matter can be provided as an app that can be downloaded from a computer-readable medium and installed on the touch device.

According to an exemplary embodiment of the present subject matter, systems and methods for dynamic reconfiguring of a user interface on a touch device are described herein. The present subject matter facilitates a user to communicate with the touch device and register the extent of his reach on a touch-screen of the touch device by providing a user swipe input on the touch-screen. In accordance with the present subject matter, the touch-screen utilizes its multi-touch capabilities to receive the user swipe input, and thus does not require any additional hardware, such as specialized sensors.

In an example, the touch-screen of touch device may receive the user swipe input when the user swipes a user input means, for example, user finger, user thumb or user stylus, from a first edge of the touch-screen to a second-edge of the touch-screen tracing a swipe boundary on the touch-screen. In an example, the first edge and the second edge can be either adjacent sides or oppositely lying sides.

In another alternative example, the touch-screen of the touch device may receive the user swipe input that may not be touching any edge of the touch-screen. In such example, the user may trace the swipe boundary by the user input means from a point nearest to the first edge of the touch-screen to a point nearest to a second edge of the touch-screen. Then, the touch device may connect that point nearest to the first edge or the second edge to respective nearest edge.

In yet another alternative example, the touch-device may include a reconfiguring mechanism to receive the user swipe input by prompting the user to touch a soft-button on the touch-screen for automatically tracing the swipe boundary. Such automatic tracing of swipe boundary is performed based on swipe history maintained over a pre-defined period of time by the reconfiguring module. Thus, when a user is prompted by the reconfiguring module for the first time, the reconfiguring mechanism may not automatically trace the swipe boundary as it has nothing stored or maintained as the swipe history. Thereafter, in an example, the reconfiguration mechanism may automatically trace the swipe boundary based on mean value of the previous traces stored in the swipe history.

Further, based on the received user swipe input, the touch device determines a user-touchable area. In an example, the user-touchable area can be either a user-defined swipe boundary area or a user-defined enclosed area enclosed by the swipe boundary and sides of the touch-screen.

In an example, the user-defined swipe boundary area is not confined to an actual area touched by the user input means. Specifically, when the user input means touches a specific part of the touch-screen, the touch device determines whether the user has slided or dragged the user input means, for example, from right to left or from left to right, estimates a swipe boundary area based on a specific touched area on the touch-screen, and determines the estimated swipe boundary area as the user-defined swipe boundary area.

In an alternative example, the user-defined enclosed area is an area enclosed between the first edge of the touch-screen, the second edge of the touch-screen, and the swipe boundary traced by the user swipe input.

Thereafter, the touch-based device dynamically reconfigures the user interface of the touch device within the user-touchable area based on reconfiguration setting.

Such reconfiguration of the user interface ensures a single handed operation of the touch device by reconfiguring the user interface within the user-touchable area. Hereinafter, the term ‘reconfiguration or reconfiguring’ may include, without any limitation, the context of restructuring, rendering, rearranging, readjusting, or repositioning.

Further, in an example, based on the reconfiguration setting, the reconfiguration of the user interface can be categorized into two categories, namely partial reconfiguration and complete reconfiguration. In said example, the reconfiguration setting may be predefined reconfiguration setting or may be set by the user.

In the partial reconfiguration, user interface (UI) elements lying within the user-touchable area retain their positions on current UI element screen, while the UI elements lying outside the user-touchable area are reconfigured within the user-touchable area on a next UI element screen. This results in an increase in the number of UI element screens.

In the complete reconfiguration, the size of all the UI elements is decreased or optimized to accommodate all the UI elements within the user-touchable area on current UI element screen. Thus, in the complete reconfiguration, the number of UI element screens is not increased, as no UI element is reconfigured on a next UI element screen.

In addition to the above listed partial reconfiguration and complete reconfiguration, many more configuration techniques can be implemented, while at the same time allowing a single handed operation by reconfiguring distant user interface (UI) elements within the reach of the user's hand to ease the interaction with those distant UI elements.

### Advantageous Effects of Invention

Thus, the exemplary embodiment of the present subject matter may provide methods and systems for reconfiguring user interface in a user-touchable area by adjusting the positions, intervals, and layout of the UI elements so that a user may conveniently manipulate the touch device with single hand.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates a touch device, according to an embodiment of the present subject matter.

FIG. 2 illustrates an exemplary user swipe input received on the touch device, according to an embodiment of the present subject matter.

FIG. 3 illustrates an exemplary implementation of partial reconfiguration of user interface on the touch device, according to an embodiment of the present subject matter.

FIG. 4 illustrates an exemplary implementation of complete reconfiguration of user interface on the touch device, according to an embodiment of the present subject matter.

FIG. 5 illustrates a method for dynamic reconfiguration of user interface on the touch device, according to an embodiment of the present subject matter.

FIG. 6 illustrates a method for dynamic reconfiguration of user interface based on direction of the user swipe input, according to an embodiment of the present subject matter.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like, represent various processes which may be substantially represented in computer readable medium and so executed by a computer or processor, whether or not such computer or processor is explicitly shown.

### MODE FOR THE INVENTION

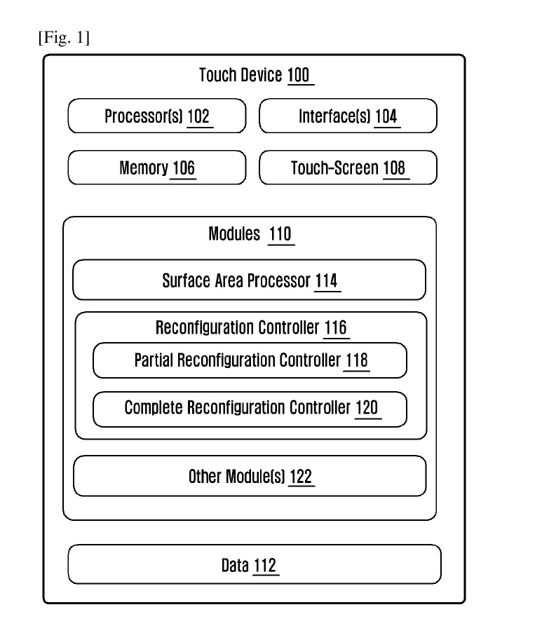

It should be noted that the description merely illustrates the principles of the present subject matter. It will thus be appreciated that various arrangements may also be employed that, although not explicitly described herein, embody the principles of the present subject matter and are included within its spirit and scope. Furthermore, all examples recited herein are principally intended expressly to be only for explanation purposes to aid the reader in understanding the principles of the present subject matter, and are to be construed as being without limitation to such specifically recited examples and conditions. Moreover, all statements herein reciting principles, aspects, and embodiments of the present subject matter, as well as specific examples thereof, are intended to encompass equivalents thereof. The manner in which the methods shall be implemented onto various systems has been explained in detail with respect to the FIGS. 1-6. While aspects of described systems and methods can be implemented in any number of different computing devices and/or configurations, the embodiments are described in the context of the following system(s).

FIG. 1 illustrates exemplary components of a touch device 100, in accordance with an embodiment of the present subject matter. In one embodiment, the touch device 100 facilitates a user to provide a user swipe input for reconfiguration of user interface (UI) on the touch device 100. The touch device 100 may be implemented as various computing devices, such as but not limited to a mobile phone, a smart phone, a personal digital assistant (PDA), a digital diary, a tablet, a net-book, a laptop computer, and the like. In one implementation, the touch device 100 includes one or more processor(s) 102, I/O interface(s) 104, and a memory 106 coupled to the processor(s) 102. The processor(s) 102 may be implemented as one or more microprocessors, microcomputers, microcontrollers, digital signal processors, central processing units, state machines, logic circuitries, and/or any devices that manipulate signals based on operational instructions. Among other capabilities, the processor(s) 102 is configured to fetch and execute computer-readable instructions stored in the memory 106.

The I/O interface(s) 104 may include a variety of software and hardware interfaces, for example, interfaces for peripheral device(s), such as a keyboard, a mouse, and an external memory. Further, the I/O interfaces 104 may facilitate multiple communications within a wide variety of protocol types including, operating system to application communication, inter process communication, etc.

The memory 106 can include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

Further, the touch device 100 may include a touch-screen 108. The touch-screen 108 is operable to display images in response to a video signal and is also operable to output a touch signal that indicates a position, on the touch-screen 108, which is touched by a user. In an example, the touch signal is generated in response to contact or proximity of a portion of the user's hand, for example, user's thumb or user's finger, with respect to the touch-screen 108. In another example, the touch signal can also be generated in response to contact or proximity of an implement, such as a stylus.

The touch-screen 108 can be implemented using any one of a number of well-known technologies that are suitable for performing the functions described herein with respect to the present subject matter. Any suitable technology now known or later devised can be employed to implement the touch-screen 108. Exemplary technologies that can be employed to implement the touch-screen 108 include resistive touch sensing, surface acoustic wave touch sensing, capacitive touch sensing, and other suitable technologies.

In an example, the touch-screen 108 can be positioned on top of a display unit having a user interface. The touch-screen 108 is substantially transparent such that the display on the display unit is visible through the touch-screen 108.

Further, in accordance with the present subject matter, the touch-screen 108 and the display unit are sized complementary to one another. The touch-screen 108 can be approximately of the same size as the display unit, and is positioned with respect to the display unit such that a touchable area of the touch-screen 108 and a viewable area of the display unit are substantially coextensive. In accordance with the present subject matter, the touch-screen 108 can be a capacitive touch-screen. Other technologies can be employed, as previously noted. In accordance with the present subject matter, the display unit is a liquid crystal display that is operable to output a touch signal in response to a user's touch on the touch-screen.

Further, in an example, the touch-screen of the present exemplary embodiment may have a relatively large screen size, compared to a related-art touch-screen. As long as a touch-screen includes the user-untouchable area, i.e., an area untouchable and/or unreachable, by the user input means according to a user's reach or an area above which the user input means cannot be placed, the present exemplary embodiment is applicable to the touch-screen.

Further, the touch device 100 may include module(s) 110 and data 112. The modules 110 and the data 112 may be coupled to the processor(s) 102. The modules 110, amongst other things, include routines, programs, objects, components, data structures, etc., which perform particular tasks or implement particular abstract data types. The modules 110 may also be implemented as, signal processor(s), state machine(s), logic circuitries, and/or any other device or component that manipulate signals based on operational instructions. In another aspect of the present subject matter, the modules 110 may be computer-readable instructions which, when executed by a processor/processing unit, perform any of the described functionalities. The machine-readable instructions may be stored on an electronic memory device, hard disk, optical disk or other machine-readable storage medium or non-transitory medium. In one implementation, the computer-readable instructions can be also be downloaded to a storage medium via a network connection.

In an implementation, the module(s) 110 includes a surface area processor 114, a reconfiguration controller 116, including a partial reconfiguration controller 118 and a complete reconfiguration controller 120, and other module(s) 122. The other module(s) 122 may include programs or coded instructions that supplement applications or functions performed by the touch device 100.

Further, the data 112 amongst other things, may serve as a repository for storing data that is processed, received, or generated as a result of the execution of one or more modules in the module(s) 110. Although the data 112 is shown internal to the touch device 100, it may be understood that the data 112 can reside in an external repository (not shown in the figure), which may be coupled to the touch device 102. The touch device 100 may communicate with the external repository through the I/O interface(s) 104 to obtain information from the data 112.

In operation, the processor(s) 102 is operable to display a user interface, in preconfigured or predefined mode, on the touch-screen 108 of the touch device 100. The user interface facilitates a user to interact with user interface (UI) elements to execute application programs installed on the touch device 100. In an example, the user can interact with the UI elements presented on the user interface by performing a “tap” operation. The “tap” operation on the touch device 100 is a form of gesture. The touch device 100 commonly supports a variety of gesture-based user commands, such as swipe gesture, pinch gesture and spread gesture, to interact with the UI elements presented on the user interface. However, in a situation when the user is holding the touch device 100 from its corner and wants to perform a single hand operation, the user may not be able to interact with few UI elements positioned away from the reach of the user.

In accordance with the present subject matter, the touch device 100 may include a UI reconfiguration mode to allow the user to switch-on and switch-off the reconfiguration of the UI based on user's reach of hand or thumb or finger. In an example, when a user wants to reconfigure the UI within the of the user's hand, the user may activate the UI reconfiguration mode. Once the UI reconfiguration mode is activated, the touch device 100 prompts the user to provide a user swipe input to reconfigure the existing UI. In response to the prompt, the user provides the user swipe input on the touch-screen 108. In an example, the user swipe input is then utilized by the touch device 100 to register the extent of user's reach on the touch-screen 108.

Further, in accordance with the present subject matter, the touch-screen 108 utilizes its multi-touch capabilities to receive the user swipe input, and thus does not require any additional hardware, such as specialized sensors, to be integrated in the existing touch-screen 108. In other words, the touch-screen 108 having multi-touch capabilities can receive the user swipe input when the user keeps maximum area of user input means in contact with the touch-screen 108 while providing the user swipe input. In an example, the user input means may include user thumb, user finger, or a user stylus.

Further, the present subject matter is not limited thereto, and the user input means may be any suitable and/or similar input means, such as any finger of a user and a stylus. It is to be understood that the user input means is not limited to a user's hand in the present subject matter.

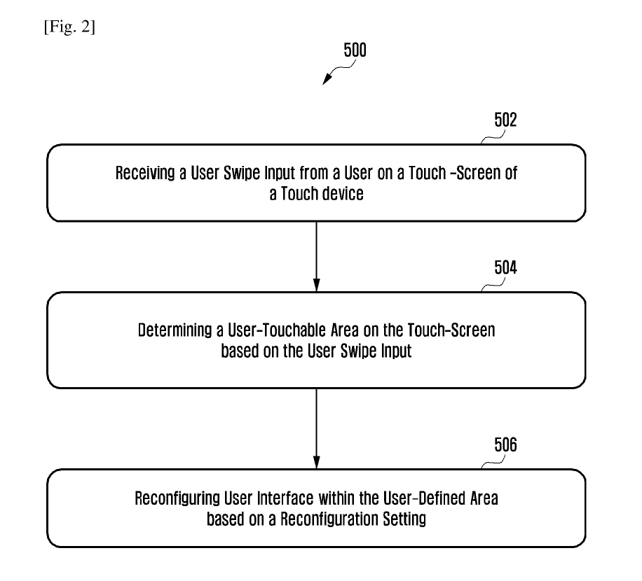

FIG. 2 illustrates an exemplary user swipe input 202 received on the touch-screen 108 of the touch device 100, according to an embodiment of the present subject matter. In an example, the user swipe input 202 may be received when the user swipes the user input means, for example, user thumb or user finger or user stylus, from a first edge 204-1 of the touch-screen 108 to a second edge 204-2 of the touch-screen 108 tracing a swipe boundary on the touch-screen 108.

In another alternative example, the touch-screen 108 of the touch device 100 may receive the user swipe input 202 that may not be touching any edge of the touch-screen 108. In such example, the user may trace the swipe boundary by the user input means from a point nearest to the first edge 204-1 of the touch-screen 108 to a point nearest to a second edge 204-2 of the touch-screen 108. Then, the touch device 100 may connect that point nearest to the first edge 204-1 or the second edge 204-2 to respective nearest edge.

In yet another alternative example, the touch-device 100 may include a reconfiguring mechanism to receive the user swipe input 200 by prompting the user to touch a soft-button on the touch-screen 108 for automatically tracing the swipe boundary. Such automatic tracing of swipe boundary is performed based on swipe history maintained over a pre-defined period of time by the reconfiguring module. Thus, when a user is prompted by the reconfiguring module for the first time, the reconfiguring mechanism may not automatically trace the swipe boundary as it has nothing stored or maintained as the swipe history.

Further, in an implementation shown in FIG. 2, the first edge 204-1 is represented as a bottom edge and the second edge 204-2 is represented as a side edge. However, in an alternative example and without any limitation, the first edge 204-1 can be any side edge and the second edge 204-2 can be a bottom or top edge.

In an alternative implementation, instead of the first edge 204-1 and the second edge 204-2 being adjacent edges as represented in FIG. 2, the first edge 204-1 and the second edge 204-2 can be oppositely lying edges. For example, the first edge 204-1 can be one side edge and the second edge 204-2 can be another side edge or a corner point. In the present alternative example, the side edges can be longitudinal edges or horizontal edges.

In yet another implementation and without any limitation, for right hander users, the first edge 204-1 can be bottom edge and the second edge 204-2 can be a right edge. Similarly, for left hander users, the first edge 204-1 can be bottom edge and the second edge 204-2 can be a left edge.

Further, in an example, the user swipe input 202, received in accordance with the present subject matter, can easily be distinguished from normal user swipe input by two identifications. Firstly, a large portion of user input means, for example, user thumb or user input, would be in contact with the touch-screen 108. Secondly, the user swipe input 202 is performed from the first edge 204-1 to the second edge 204-2 of the touch-screen 108, and vice versa. That is, the user swipe input 202 connects the first edge 204-1 of the touch-screen 108 with the second edge 204-2 of the touch-screen 108. It will be understood that other identifications, such as the reconfiguration mode being in active mode, can also be used.

Yet further, in an example, as can be seen in FIG. 2, the user swipe input 202, received in accordance with the present subject matter, defines a user-touchable area. In an example, the user-touchable area can be either a user-defined swipe boundary area or a user-defined enclosed area 206 enclosed by the swipe boundary and sides of the touch-screen 108.

In an example, the user-defined swipe boundary area is not confined to an actual area touched by the user input means. Specifically, when the user input means touches a specific part of the touch-screen 108, the touch device 100 determines whether the user has slided or dragged the user input means, for example, from right to left or from left to right, estimates a swipe boundary area based on a specific touched area on the touch-screen 108, and determines the estimated swipe boundary area as the user-defined swipe boundary area.

In an alternative example, the user-defined enclosed area 206 is an area enclosed on the touch-screen 108 within the first edge 204-1 of the touch-screen 108, the second edge 204-2 of the touch-screen 108, and the swipe boundary traced by the user swipe input 202.

In another alternative example, when the user swipe input 202 connects the two side edges, the user-defined swipe boundary area or a user-defined enclosed area 206 can be enclosed between two side edges, one bottom edge, and the user swipe input 202.

Now, once the user swipe input 202 is received, the surface area processor 114 determines a value of the user-touchable area and compares the determined value of the user-touchable area with a predefined threshold area. In an example, the predefined threshold area is defined based on an average length of a human thumb or a human finger or a stylus. Based on the comparison, in case the value of the user-touchable area is determined below a predefined threshold area, the surface area processor 114 may prompt the user to again provide the user swipe input 202.

Thereafter, once the surface area processor 114 confirms that the value of the user-touchable area is above the predefined threshold area, the reconfiguration controller 116 makes a decision on what type of reconfiguration of the UI elements is to be executed. The decision depends on the reconfiguration setting for the user interface of the touch device 100. In an example, the touch device 100 may include the user-definable reconfiguration setting that enables the user to define the reconfiguring setting for the user interface under two categories, namely partial reconfiguration and complete reconfiguration.

In accordance with an exemplary implementation, the user may define the configuration of the UI based on the direction of the user swipe input 202. For example, the user can define the user-definable reconfiguration setting that the partial reconfiguration is performed when the touch-screen 108 receives the user swipe input 202 in upward direction from the first edge 204-1 of the touch-screen 108 to the second edge 204-2 of the touch-screen 108. Similarly, the user can define the user definable reconfiguration setting that the complete reconfiguration is performed when the touch-screen 108 receives the user swipe input 202 in downward direction from the second edge 204-2 of the touch-screen 108 to the first edge 204-1 of the touch-screen 108.

In accordance with an alternative implementation, the user can define the user definable reconfiguration setting that the partial reconfiguration is performed when the touch-screen 108 receives the user swipe input 202 in downward direction from the second edge 204-2 of the touch-screen 108 to the first edge 204-1 of the touch-screen 108. Similarly, the user can define the user definable reconfiguration setting that the complete reconfiguration is performed when the touch-screen 108 receives the user swipe input 202 in upward direction from the first edge 204-1 of the touch-screen 108 to the second edge 204-2 of the touch-screen 108.

In yet another implementation, the user can receive a prompt on providing the user swipe input and in response to the prompt can select whether a partial reconfiguration or a complete reconfiguration is to be done.

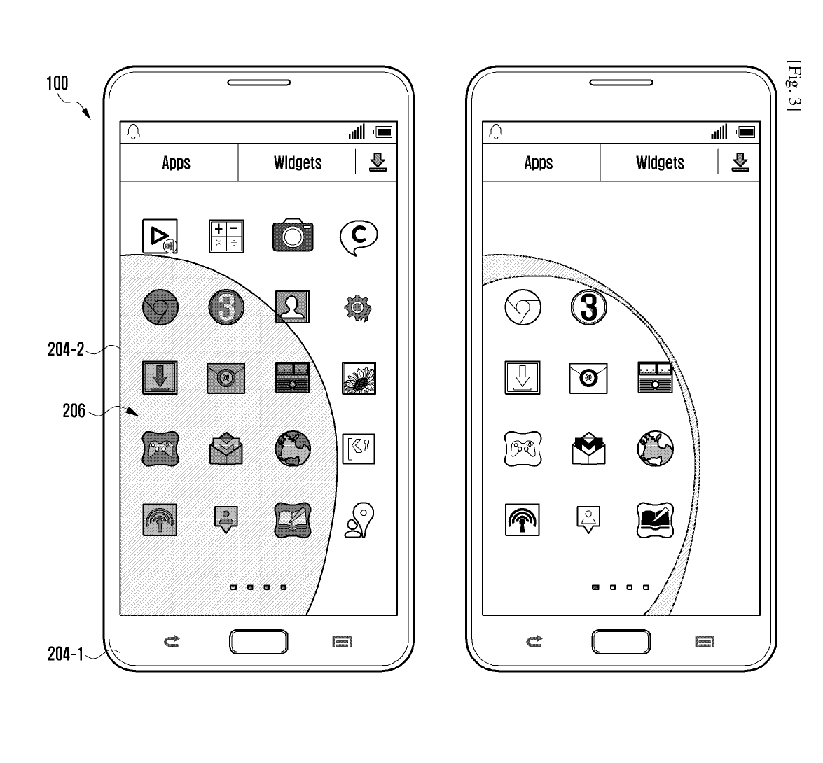

Further, in an exemplary embodiment shown in FIG. 3, in case the reconfiguration controller 116 makes a decision to perform the partial reconfiguration of the user interface based on the reconfiguration setting, the partial reconfiguration controller 118 is invoked to perform the partial reconfiguration of the user interface within the user-defined enclosed area 206 enclosed by the user swipe input 202. Thereafter, the partial reconfiguration controller 118 retains the positions of user interface (UI) elements lying within the user-defined enclosed area 206 on a current UI element screen, while reconfigure positions of UI elements lying outside the user-defined enclosed area 206 onto a next UI element screen within the user-defined enclosed area 206.

For example, as can be seen in right side of FIG. 3, UI elements, such as calculator, voice recorder, phone, contacts, messaging, internet, ChatON, Samsung apps, Samsung Link, WatchON, and Video, lying within the user-defined enclosed area 206 retain their positions, while the UI elements, such as clock, S Planner, Camera, Gallery, Settings, Email, Samsung Hub, and Music, lying outside the user-defined enclosed area 206 are reconfigured or moved on to next UI element screen within the user-defined enclosed area 206. Thus, in the partial reconfiguration, a number of UI element screens containing the UI elements may increase. However, in the partial reconfiguration, the size of the UI elements is not scaled down to adjust into the user-defined enclosed area 206.

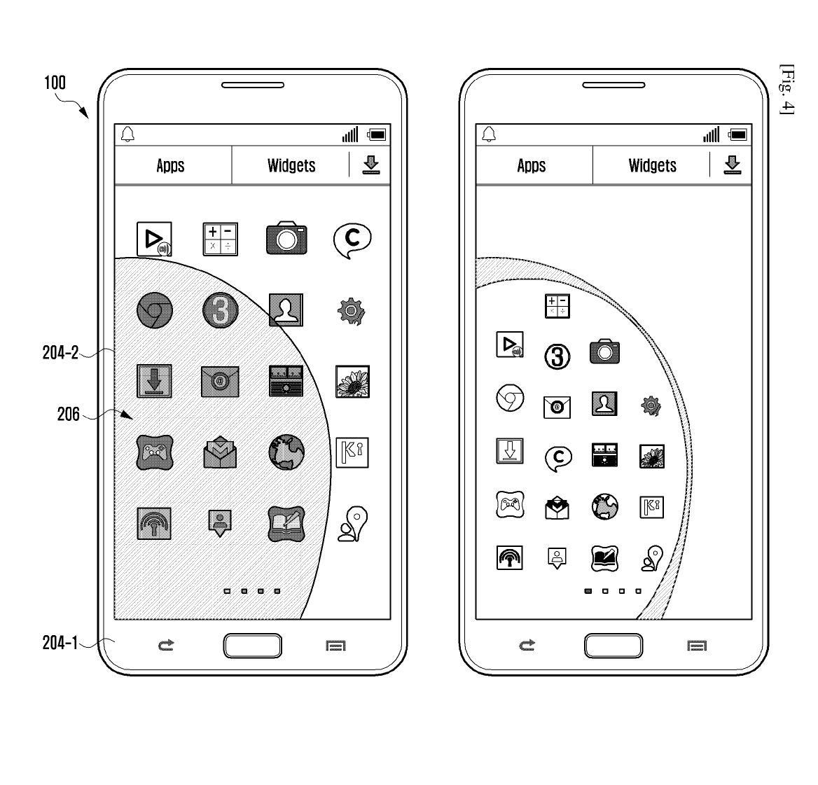

Yet further, in another exemplary embodiment shown in FIG. 4, in case the reconfiguration controller 116 makes a decision to perform the complete reconfiguration of the user interface based on the reconfiguration setting, the complete reconfiguration controller 120 is invoked to perform the complete reconfiguration of the user interface within the user-defined enclosed area 206. Thereafter, the complete reconfiguration controller 120 optimizes or scales down the size of all user interface (UI) elements to accommodate within the user-defined enclosed area 206 on a current UI element screen. The optimized or scaled down UI elements are then reconfigured or shrank within the user-defined enclosed area 206.

For example, as can be seen in right side of FIG. 4, size of all the UI elements is scaled down to adjust all the UI elements within the user-defined enclosed area 206 enclosed on the touch-screen 108. Thus, in the complete reconfiguration, a number of UI element screens on the touch device 100 are not decreased as no UI element is reconfigured or moved to next UI element screen. However, in the complete reconfiguration, the visibility of the elements is affected due to scaling down of the size of all the UI elements.

The reconfiguration of the user interface is performed by using the technologies known in the art to a skilled person. Such technologies may divide an existing display area for the reconfigured user interface, into a plurality of sub-areas and calculates the coordinates of each sub-area. Thereafter, a mapping relationship between the coordinates of the actual display area and the coordinates of the reconfigured display sub-area is determined, so as to display the reconfigured user interface. However, those of ordinary skill in the art will recognize that various changes and modifications of the embodiments described herein can be made without departing from the scope and spirit of the present subject matter. In addition to that, descriptions of well-known functions and constructions for reconfiguration of the user interface are omitted in the description provide herein for clarity and conciseness.

While the present subject matter has been shown and described with reference to certain exemplary embodiments thereof, it will be understood by those skilled in the art that various changes in form and details may be made therein without departing from the scope of the present subject matter as described herein.

Further, as mentioned above, in addition to the partial reconfiguration and the complete reconfiguration, any other reconfiguration technique can be implemented to restructure distant user interface (UI) elements within the user-touchable area, which is defined within the reach of the user's hand to motivate a single handed operation.

Thus, by implementing the above mentioned reconfiguration techniques, the present subject matter provides convenience to a user for interacting with distant UI elements even when the distant UI elements are positioned beyond a single hand operational capability of the user. The present subject matter facilitates the mentioned convenience by dynamically reconfiguration of the user interface within the user-touchable area computed based on the user swipe input 202. Such reconfiguration of the user interface ensures that all the UI elements on the user interface are within the reach of the user during a single hand operation.

Further, the present subject matter is implemented on existing touch-screen computing device, and thus does not require any additional hardware.

Moreover, as can be seen in FIG. 3 and FIG. 4, a portion outside the user-touchable area or user-defined enclosed area 206 of the reconfigured user interface, is left unutilized. The said portion outside the user-touchable area or user-defined enclosed area 206 can be used to preview images, videos, contacts, grids of files/folders, or other preview-able files or items. The setting for the said portion can be made through user definable reconfiguration setting of the touch device 100.

In an example, the reconfigured user interface may include soft-keys representing the functionality of the hard-keys of the touch device 100. This ensures that the user may not have to stretch his hand to reach the hard-keys provided on the top of the touch device 100.

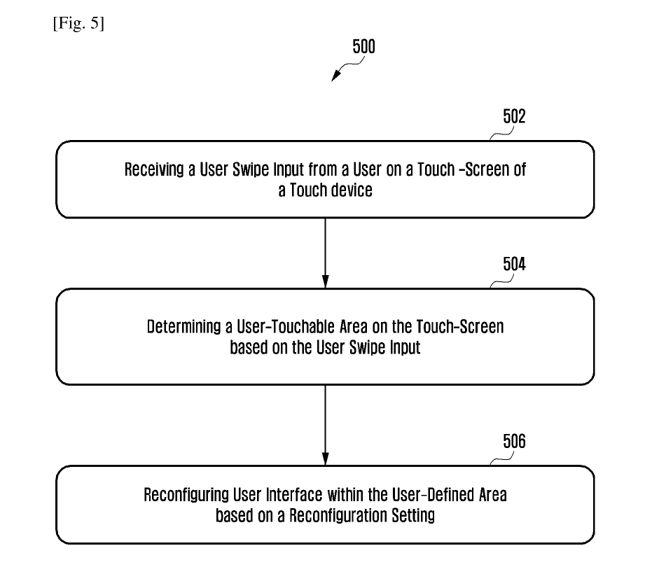

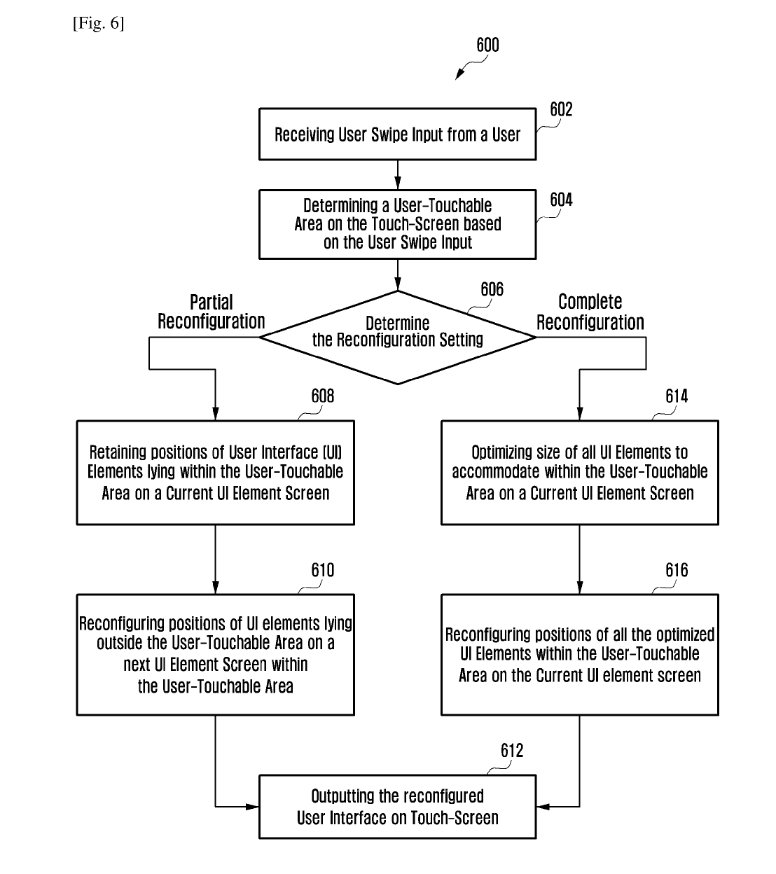

The operation of touch device 100 is further explained in conjunction with FIG. 5 and FIG. 6. FIG. 5 and FIG. 6 illustrate methods 500 and 600 for reconfiguration of user interface on a touch device 100. The order in which the methods 500 and 600 is described is not intended to be construed as a limitation, and any number of the described method blocks can be combined in any order to implement the methods, or alternative methods. Additionally, individual blocks may be deleted from the methods without departing from the spirit and scope of the subject matter described herein.

The methods may be described in the general context of computer executable instructions. Generally, computer executable instructions can include routines, programs, objects, components, data structures, procedures, modules, functions, etc., that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

A person skilled in the art will readily recognize that steps of the methods 500 and 600 can be performed by programmed computers and computing devices. Herein, some embodiments are also intended to cover program storage devices, for example, digital data storage media, which are machine or computer readable and encode machine-executable or computer-executable programs of instructions, where said instructions perform some or all of the steps of the described method. The program storage devices may be, for example, digital memories, magnetic storage media, such as a magnetic disks and magnetic tapes, hard drives, or optically readable digital data storage media. The embodiments are also intended to cover both communication network and computing devices configured to perform said steps of the exemplary method.

Referring to FIG. 5, at block 502, a user swipe input 202 is received from a user on a touch-screen 108. In an example, the touch-screen 108 of the touch device 1000 may receive the user swipe input 202 when the user swipes user input means, for example, user thumb or user finger or user stylus, from a first edge 204-1 of the touch-screen 108 to a second edge 204-2 of the touch-screen 108 tracing a swipe boundary on the touch-screen 108.

At block 504, based on the received user swipe input 202, the surface area receiver 114 of the touch device 100 determines a user-touchable area. In an example, the user-touchable area. In an example, the user-touchable area can be either a user-defined swipe boundary area or a user-defined enclosed area 206 enclosed by the swipe boundary and sides of the touch-screen.

At block 506, a reconfiguration controller 116 reconfigures the user interface present on the touch-screen 108 within the user-touchable area based on reconfiguration setting. Such reconfiguration of the user interface ensures a single handed operation of the touch device 100 by positioning all the user interface (UI) elements within the user-defined enclosed area 206 of the user.

The operation of reconfiguration of the user interface is further explained in detail in conjunction with FIG. 6. FIG. 6 describes the method 600 for reconfiguration of the user interface on the touch device 100, in accordance with one implementation of the present subject matter.

At block 602, a user swipe input 202 is received from a user on a touch-screen 108. In an example, the touch-screen 108 of the touch device 1000 may receive the user swipe input 202 when the user swipes user input means, for example, user thumb or user stylus, from a first edge 204-1 of the touch-screen 108 to a second edge 204-2 of the touch-screen 108.

At block 604, based on the received user swipe input 202, the surface area receiver 114 of the touch device 100 determines a user-touchable area. In an example, the user-touchable area can be either a user-defined swipe boundary area or a user-defined enclosed area 206 enclosed by the swipe boundary and sides of the touch-screen.

At block 606, based on a reconfiguration setting, a reconfiguration controller 116 makes a decision on what type of reconfiguration of the user interface is to be executed. For example, based on the reconfiguration setting, a partial reconfiguration would be performed when the user swipe input 202 in provided in an upward direction, while a complete reconfiguration would be performed when the user swipe input 202 in provided in downward direction, and vice versa.

Thus, in an example, the reconfiguration of the user interface can be categorized into two categories, namely the partial reconfiguration and the complete reconfiguration, based on the direction of the user swipe input 202. For example, the partial reconfiguration is performed when the reconfiguration controller 116 detects the user swipe input 202 in a direction from the first edge 204-1 of the touch-screen 108 to the second edge 204-2 of the touch-screen 108. Similarly, the complete reconfiguration is performed when the reconfiguration controller 116 detects the user swipe input 202 in a direction from the second edge 204-2 of the touch-screen 108 to the first edge 204-1 of the touch-screen 108.

In an exemplary embodiment, in case the reconfiguration controller 116 detects that the partial configuration is to be performed, the reconfiguration controller 116 invokes the partial reconfiguration controller 118 to perform the partial reconfiguration of the user interface within the user-defined enclosed area 206 enclosed by the user swipe input 202.

At block 608, the partial reconfiguration controller 118 retains positions of UI elements lying within the user-defined enclosed area 206 on a current UI element screen. That is, the UI elements lying within the user-defined enclosed area 206 are left unchanged on the touch-screen 108 of the touch device 100.

At block 610, the partial reconfiguration controller 118 reconfigures positions of UI elements lying outside the user-defined enclosed area 206 onto a next UI element screen. That is, the UI elements lying outside the user-defined enclosed area 206 are reconfigured or moved within the user-defined enclosed area 206 on the next UI element screen.

At block 612, once the partial reconfiguration is performed, the reconfigured user interface is outputted on a display unit of the touch device 100.

In another exemplary embodiment, in case the reconfiguration controller 116 detects that the complete configuration is to be performed, the reconfiguration controller 116 invokes the complete reconfiguration controller 120 to perform the complete reconfiguration of the user interface within the user-defined enclosed area 206 enclosed by the user swipe input 202.

At block 614, the complete reconfiguration controller 120 optimizes or scale down the size of all UI elements in such a way that the optimized or scaled down UI elements may accommodate within the user-defined enclosed area 206 on a current UI element screen.

At 616, once the size of all the UI elements is optimized or scaled down, the optimized or scaled down UI elements are reconfigured or shrank within the user-defined enclosed area 206 on the current UI element screen.

At 612, once the complete reconfiguration is performed, the reconfigured user interface is outputted on the display unit of the touch device 100.

Thus, by implementing the reconfiguration techniques mentioned in the present subject matter, user interface or all user interface elements are positioned within a user-defined enclosed area 206 or a user-touchable area lying within the reach of a user, so as to facilitate a single handed operation of the touch device 100.

As is apparent from the above description of the present subject matter, since a user-touchable area is set in a display area of the touch-screen and UI elements are reconfigured in the user-touchable area by adjusting the positions and sizes of the UI elements in the touch device, a user experience is enhanced. Furthermore, such reconfiguration of the UI elements may utilize less number of computing resources as compared to the related art touch devices as the reconfigured UI elements utilizes a partial area of the touch-screen as a user interface.

Although embodiments for methods and systems for the present subject matter have been described in a language specific to structural features and/or methods, it is to be understood that the present subject matter is not necessarily limited to the specific features or methods described. Rather, the specific features and methods are disclosed as exemplary embodiments for the present subject matter.

1. A method for reconfiguring a user interface (UI) on a touch device, the method comprising:
receiving a user swipe input from a user on a touch-screen of the touch device;
determining a user-touchable area on the touch-screen based on the user swipe input; and
reconfiguring the UI on the touch-screen within the user-touchable area based on a reconfiguration setting.

2. The method of claim 1, wherein the user-touchable area is one of a user-defined swipe boundary area and a user-defined enclosed area.

3. The method of claim 1, wherein the receiving comprises one of:
tracing a swipe boundary by a user input means from a first edge of the touch-screen to a second edge of the touch-screen;
tracing a swipe boundary by the user input means from a point nearest to the first edge of the touch-screen to a point nearest to a second-edge of the touch-screen; and
tracing a swipe boundary by touching a soft-button provided on the touch-screen using the user input means.

4. The method of claim 2, wherein the tracing the swipe boundary by touching the soft-button comprises tracing the swipe boundary based on mean value of previous swipe boundaries traced by touching the soft-button.

5. The method of claim 4, wherein the previous swipe boundaries are stored as a swipe history in the touch device.

6-8. (canceled)

9. The method of claim 1, wherein based on the reconfiguration setting, the reconfiguring comprises:
retaining positions of UI elements lying within a user-touchable area on a current UI element screen; and
reconfiguring positions of UI elements lying outside the user-touchable area on a next UI element screen within the user-touchable area.

10. The method of claim 1, wherein based on the reconfiguration setting, the reconfiguring comprises:
optimizing size of the UI elements to accommodate within the user-touchable area on a current UI element screen; and
reconfiguring positions of all the optimized UI elements within the user-touchable area on the current UI element screen.

11. The method of claim 1 further comprising prompting the user to again provide the user swipe input when the user-touchable area is determined to be below a predefined threshold area of the touch-screen.

12. The method of claim 1, wherein after the reconfiguring, the method comprises previewing at least one item in a portion, outside the user-touchable area, of the touch-screen.

13. The method of claim 1 further comprising representing hard-keys of the touch device as soft-keys in the reconfigured UI.

14. A touch device comprising:
a processor;
a touch-screen, coupled to the processor, to receive a user swipe input from a user;
a surface area processor, coupled to the processor, to determine a user-touchable area based on the user swipe input; and
a reconfiguration controller, coupled to the processor, to reconfigure a user interface (UI) on the touch-screen within the user-touchable area based on a reconfiguration setting.

15. The touch device of claim 14, wherein the user-touchable area is one of a user-defined swipe boundary area and a user-defined enclosed area.

16. The touch device of claim 14, wherein the touch-screen receives the user swipe input by one of:
tracing a swipe boundary on the touch-screen using a user input means from a first edge of the touch-screen to a second edge of the touch-screen;
tracing a swipe boundary by a user input means from a point nearest to the first edge of the touch-screen to a point nearest to a second-edge of the touch-screen; and
tracing a swipe boundary by touching a soft-button provided on the touch-screen using the user input means.

17. The touch device of claim 16, wherein the touch device comprises a reconfiguration mechanism that traces the swipe boundary based on mean value of previous swipe boundaries traced by touching the soft-button.

18. The touch device of claim 17, wherein the previous swipe boundaries are stored as a swipe history in the touch device.

19-21. (canceled)

22. The touch device of claim 14, wherein the touch device comprises a partial reconfiguration controller to:
retain positions of UI elements lying within a user-defined enclosed area on a current UI element screen, and
reconfigure positions of UI elements lying outside the user-defined enclosed area on a next UI element screen in the user-defined enclosed area.

23. The touch device of claim 14, wherein the touch device comprises a complete reconfiguration controller to:
optimize size all UI elements to accommodate within the user-defined enclosed area on a current UI element screen, and
reconfigure positions of all the UI elements within the user-defined enclosed area on the current UI element screen.

24. The touch device of claim 14, wherein the surface area processor prompts the user to again provide the user swipe input when the user-touchable area is determined to be below a predefined threshold area of the touch-screen.

25. The touch device of claim 14, wherein the reconfiguration controller previews at least one item in a portion, outside the user-touchable area, of the touch-screen.

26. The touch device of claim 14, wherein the reconfigured user interface comprises soft-keys representing the functionality of the hard-keys of the touch device.

27. (canceled)
